(19) United States
(12) Patent Application Publication
(10) Pub. No.: US 2008/0133974 A1
(43) Pub. Date: Jun. 5, 2008

(54) MEDIA PLAYER TEST FIXTURE

(75) Inventors: Douglas J. Kogan, Sandy, UT (US); Steven T. Baker, Salt Lake City, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/565,090

(22) Filed: Nov. 30, 2006

(51) Int. Cl. G06F 11/36

(52) U.S. Cl. 714/38; 714/E11.212

(57) ABSTRACT

Testing media player devices. A method may be practiced, for example, in an automated testing environment. The method includes sending a media oriented command to the media player. The command directs the media player to perform a media function. A trace is received in response to the command. The trace may be generated by a media player as part of the process of attempting to perform functionality related to the command. The trace includes media player information. The information occurs as a result of sending the command to the media player. In response to receiving a trace, a new media oriented command is sent automatically and without human intervention directing the media player to perform a media function. The new media oriented command is dependent on the trace.

### BACKGROUND

1. The Field of the Invention

The invention is generally directed to a test fixture for testing electronic components. More specifically, the invention is directed to testing media player components.

2. Description of the Related Art

In manufacturing environments, there is typically a need to test devices manufactured by the manufacturer. Some testing has typically required a significant amount of human interaction. For example, in the context of media devices, such as set top boxes and multimedia players, a human test technician may be required to use an interface such as an infrared remote control, to test the devices functionality.

Illustratively, a production line may have actual human testers who test media devices. The human testers may connect a media player device to a display so as to be able to discern the state of the media player. At the display, a user can assess if a media file is playing, a location of the media file that is being played, etc. Further, a user can manipulate various keys on a remote control device, such as a wireless infrared remote control, to determine how the media player responds to the key manipulation.

Understandably, by using human testers, there is room for human error. Additionally, the subjective nature of human judgment may result in one tester certifying a media player as acceptable, while another tester may reject the media player. Further, the cost to employ human testers can be expensive.

However, especially in the field of media players, it is difficult to move away from human testers. In particular, the functionality of a media player is most often evaluated based on perceived audio and video stimulus. While humans may be able to readily interpret the audio and video stimulus, automated test equipment is less able to monitor the audio and video stimulus.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes acts for implementing a method of testing media player devices. The method may be practiced, for example, in an automated testing environment. The method includes sending a media oriented command to the media player. The command directs the media player to perform a media function. A trace is received in response to the command. The trace includes media player information. The information occurs as a result of sending the command to the media player. In response to receiving a trace, a new media oriented command is sent automatically and without human intervention directing the media player to perform a media function. The new media oriented command is dependent on the trace.

In another embodiment from a media player perspective, a method of testing the media player may be implemented. The method may be implemented, for example, in an automated testing environment for testing media players. The method includes receiving a media oriented command at the media player. The command directs the media player to perform a media function. An attempt is made to perform a function defined by the media oriented command. A trace is sent in response to the command. The trace including media player information. The media player information occurring as a result of attempting to perform the function defined by the media oriented command. In response to sending a trace, a new media oriented command is received that is generated automatically and without human intervention directing the media player to perform a media function. The new media oriented command is dependent on the trace.

Other embodiments may be implemented including devices configured to perform the preceding methods. Additionally, computer readable media including computer executable instructions may be implemented for performing the acts described above.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a test topology;

FIG. 2 illustrates various acts that may be performed to update and test a device; and

FIG. 3 illustrates an exemplary testing method.

### DETAILED DESCRIPTION

One embodiment described herein allows testing of a media player device to be accomplished in an automated fashion by the use of trace information. For example, the trace information may be embedded in a signal, such as a multimedia signal, that would be returned in response to a command, such as a command from an infrared remote control or an emulated command from an emulated remote control. Illustratively, when a particular multimedia file is requested, trace information may be embedded in the returned file or in returned streaming content. The trace information may indicate various pieces of information such as file position information, file name information, error information, information ordinarily displayed at a media player display, command execution status information, media player state information, etc.

The trace information may be used in automatically formulating a new command based on what is in the trace information. For example, if an error is indicated, a command may be retried. If the trace information indicates that a file has completed playing, a new command specifying a new file to be played may be generated. When one command has been successfully tested a new command may be tested. New commands may be sequentially tested until all commands slated for testing have been tested.

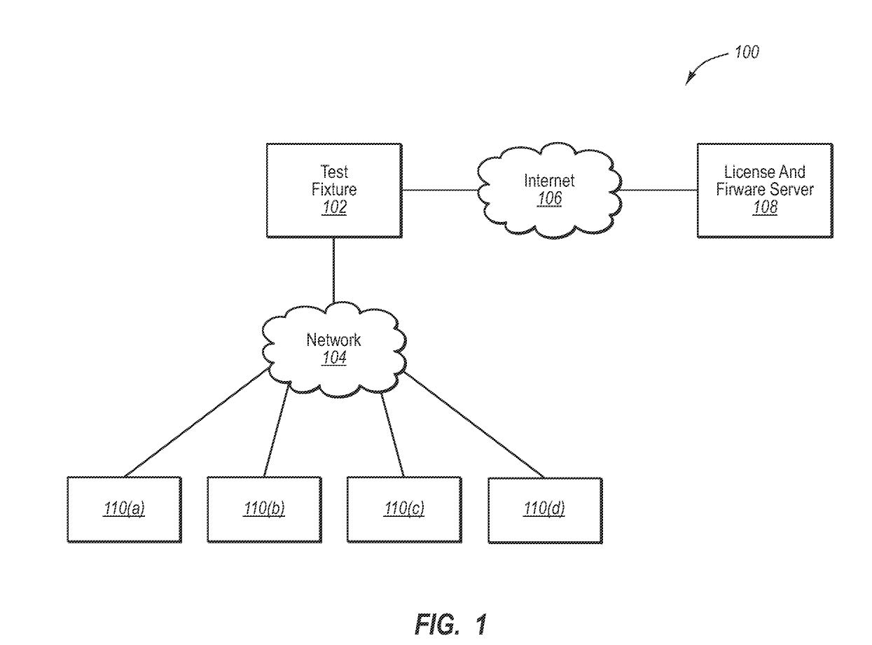

Referring now to FIG. 1, an illustrative environment where some embodiments may be practiced is illustrated. In particular, FIG. 1 illustrates a test fixture 102. The test fixture 102 may be configured with test fixture software. In particular, in one embodiment, the test fixture may include a computer system which includes an operating system such as Windows XP service pack 2, or other suitable operating system. The test fixture PC may further include test fixture software and a Universal Plug and Play (UPnP) server such as Windows Media Connect, Intel Micro Media server, or other appropriate UPnP server. The test fixture 102 may include network connectivity when a network is used to connect to devices for testing the devices. For example, the test fixture 102 may have an interface allowing for connection to a wired Ethernet network. Alternatively or additionally, the test fixture 102 may include connectivity to wireless networks such as IEEE 802.11g wireless networks or other appropriate networks. In one embodiment, the test fixture 102 further includes connectivity to the Internet 106. This allows the test fixture 102 to obtain licenses and/or firmware from a license and firmware server 108. The license and firmware server 108 may be administered by a functionality provider as will be discussed in more detail below. In one embodiment, the test fixture 102 may include a graphical user interface (GUI) that permits manual configuration of testing parameters.

As illustrated in FIG. 1, the test fixture 102 is connected to a network 104. Devices 110 are also connected to the network 104. The devices 110 may be for example media player devices which stream multimedia content from a UPnP server for playback to a user. In particular, the devices 110 may include a display such as a television screen display and audio output equipment, or may include functionality for connecting to an external display and external audio equipment. Content, such as photos, music, videos, or other multimedia content can be provided to a user through the display and/or audio equipment integral to the device 110 or connected to the device 110. Exemplary devices are illustrated in U.S. patent application Ser. No. 11/427,496 titled DUAL PROCESSOR BASED DIGITAL MEDIA PLAYER ARCHITECTURE WITH NETWORK SUPPORT filed on Jun. 29, 2006 which is incorporated herein by reference in its entirety.

As explained previously, the test fixture 102 may include functionality for verifying playback functionality of the device 110. Additionally, the test fixture may include functionality for verifying remote control functionality. In particular, to verify playback functionality, the test fixture 102 in the example illustrated, includes user video recognition emulation. This may be accomplished by using a trace signal which includes various pieces of information that would typically be discernible by visually inspecting a screen to which multimedia data is transmitted for display or listening to audio prompts transmitted to audio equipment integral to or connected to the device 110. The test fixture 102 further includes remote emulation functionality for verifying remote control functionality. This may be accomplished, in one embodiment, by sending commands over the network 104 to a device 110. The commands may include multimedia type commands including trick commands such as play, stop, fast-forward, rewind, etc. Additionally, multimedia type commands used for navigation may also be emulated and sent over the network 104 to a device 110. Such navigation commands may include file selection commands, page up or page down commands, and the like.

User video recognition and emulation will now be explained in more detail. As explained previously, a trace signal may be sent by the device 110 through the network 104 to the test fixture 102. The trace signal may be embedded in streaming data or in a file returned by the device 110. The trace signal may provide one or more of a number of different details regarding the media being provided by the device 110 and/or the state of the device 110.

For example, the trace information may include file position information. Illustratively, the trace information may include information specifying a number of minutes, seconds, and partial seconds into a streaming file. In an alternative embodiment, the trace information may include a number of bytes into a file. Illustratively, a remote emulation command may be sent from the text test fixture 102 to a device 110. The remote emulation command may be for example a play command, a fast-forward command, a rewind command, a pause command, or other command that affects which part of a multimedia file a user would expect to view. The file position information included in the trace information may be compared to an expected file position to determine if the device 110 is functioning properly.

In another example, the trace information may include information defining the name of a file being accessed. Illustratively, the tests fixture 102 may send a remote emulation command directed to selecting a file for streaming to the device 110. Such a command may include various navigation commands, file selection commands, and confirmation commands.

In some embodiments, the user video recognition and emulation command trace may include error information. For example, if a file fails to play, a file is not found, or other error occurs as the result of a remote emulation command, an error trace can be returned. The test fixture 102 may be configured to respond to the error in a fashion similar to how a user would respond if an error such as the one indicated in the trace information were displayed to a user at a screen instead. Thus, the text fixture can be used to automatically simulate the interaction of a human user.

In one example, the trace may include device 110 state information. For example, the trace may include an indication of menu structure that would be displayed given certain commands. Illustratively, navigation commands may be sent to the device 110 from the test fixture 102 using the remote emulation command. For example, commands such as a menu selection command, up and or down arrows, left or right arrows, new page, select commands and the like may be sent. The receipt of these commands causes the device 110 to be in a particular state. For example, a particular menu may be displayed. Information defining the particular menu or other device state information may be included in the trace information. This information may be compared to expected state information to determine if the device 110 is behaving as expected.

The trace information may further include command execution status information. For example, the trace information may include an indication of the status of a requested command. For example, if a command to play a file has been sent to the device 110, the trace information may include information specifying what actions have been or are being undertaken by the device 110 to play the file. For example, the trace may indicate that a request has been sent to a UPnP server for the file. The trace may indicate that portions of the file have been received. The trace may indicate that the device 110 is attempting to decode a file or streamed data, etc.

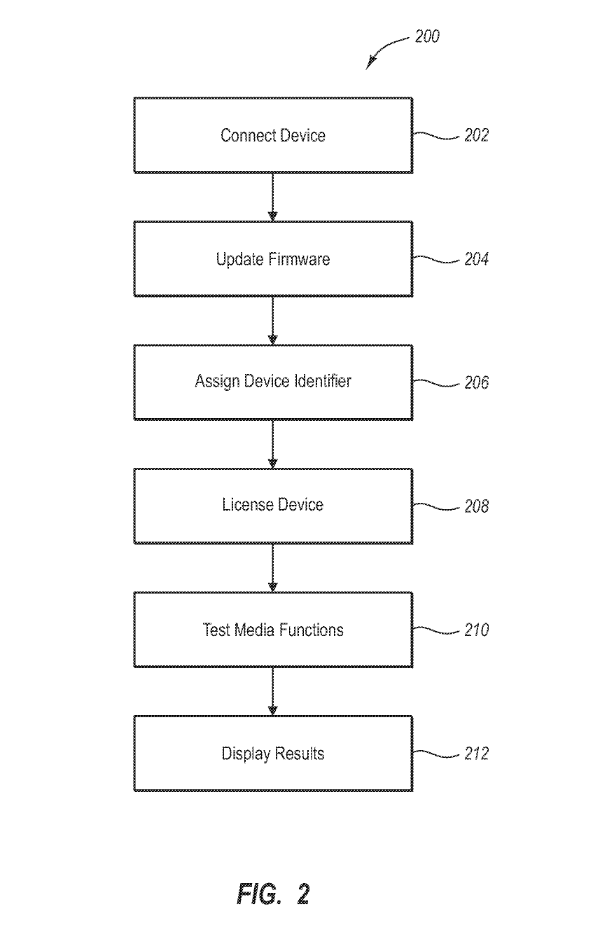

Referring now to FIG. 2 an exemplary test and configuration procedure is illustrated. FIG. 2 illustrates at 202 that a device 110 is connected to the test fixture 102 (act 202). Connecting the device 110 to the test fixture 102 may include connecting the device 110 to the network 104. In one embodiment, the test fixture 102 detects that a new device 110 has been added to the network through the test fixtures universal plug and play server functionality. The test fixture 102 then adds the newly added device 110 to a pending test queue. Notably, in one embodiment, to enable the ability of the device to be connected to the test fixture 102, the device may first have an initial binary image loaded into firmware. The binary image may include computer executable instructions that provide basic networking functionality as well as any other desired functionality. The initial binary may be able to connect to a universal plug and play server for basic functionality, but may have functionality for connecting to a media universal plug and play server disabled.

FIG. 2 further illustrates updating firmware on the device (act 204). Illustratively, the test fixture 104 can check to see if there are firmware updates available for the device 110. For example, the test fixture 102 may contact the license and firmware server 108 through the Internet 106. The test fixture 102 can provide information to the license and firmware server indicating the firmware currently installed on the device 110. The license and firmware server 108 can then send a new firmware image to the test fixture for installation on the device 110 if a new firmware image is available. The device 110 receives the firmware image from the test fixture 102 and installs the firmware image on the device. The device 110 notifies the test fixture 102 once the firmware image has been installed. The device 110 may then reboot such that the new firmware is used in the device 110. In some embodiments, the new firmware may be stored at the test fixture 102 in a firmware pack provided by a functionality provider. As such, contacting the license and firmware server 108 can be avoided by instead accessing the local firmware pack to obtain updated firmware.

FIG. 2 further illustrates assigning a device identifier (act 206). For example, in one embodiment, a unique device identifier, or unique to the manufacturer device identifier may be applied to the device 110 by the test fixture 102. The device identifier may supersede any other device identifier such as those assigned to network hardware in the device 110. In one embodiment, the device identifier may be a MAC address. In other embodiments, the device identifier may be an identifier other than a MAC address.

FIG. 2 further illustrates an act of licensing the device (act 208). Licensing devices is discussed in more detail in U.S. patent application Ser. No. 11/564,999 titled LICENSE VERIFICATION filed concurrently herewith and which application is incorporated herein by reference in its entirety. In one particular embodiment, the devices 110 may be licensed on a unit by unit basis. Specifically, the test fixture 102 may have access to a license pack file that contains licensing images for specific devices. The license for a particular device under test can be obtained from the license pack file and applied to the particular device 110. When a license images is applied to a device 110, certain functionality can then be enabled on the device 110 making the device 110 suitable for further sale or for end user use. For example, in one embodiment the devices ability to act as a client to a universal plug and play media server can be enabled. This helps to ensure that a manufacture pays appropriate licensing and royalty fees by only allowing functionality to be enabled on devices for which the appropriate license or royalty fee has been paid.

In one embodiment, the licensing image may be obtained by the test fixture 102 from the license and firmware server 108. This allows a device manufacturer to use any component in the device 110 that supports the functionality and without the need to store the particular license image for the device 110 at the manufacturing facility. The functionality provider that controls the license and firmware server 108 can nonetheless provide a device specific license image such that the licensing image cannot be used for other devices. When a device specific license images provided to the test fixture 102, the functionality provider using the licensing and firmware server 108 can track the number of licenses granted to a particular manufacturer for a particular device model and/or decrement a number indicating the number of licenses purchased for the particular device model. In some embodiments, application of the license image may result in a change to the MAC address. If this occurs, then the device 110 may be rebooted to apply the changes.

FIG. 2 further illustrates an act of testing media functions act (210). Various testing may be performed including testing navigation functionality and a devices ability to play multimedia files. As described previously, remote commands may be emulated on the network 104 connection. In one embodiment, this is enabled by the use of a dual processor device 110, where one processor is a media processor that processes multimedia content, and the second processor is a network processor that includes functionality for connecting to a network. The network processor can include functionality for sending remote commands to the media processor such that the media processor responses to the remote commands may be evaluated. An exemplary two processor device is disclosed in U.S. patent application Ser. No. 11/427,496 titled DUAL PROCESSOR BASED DIGITAL MEDIA PLAYER ARCHITECTURE WITH NETWORK SUPPORT filed on Jun. 29, 2006 which is incorporated herein by reference in its entirety.

In one embodiment, to test playback functionality, a sample video clip may be played by the device 110. The test procedure may include testing of wired and/or wireless connectivity to the UPnP server as well as device playback ability and navigation ability.

In one embodiment, clips may be specifically identified for wired or wireless operation testing. If a wireless clip is identified, the test fixture 102 may be configured to automatically configure the device 110 for wireless operation. For example, the test fixture may be configured to send commands, such as remote emulation commands, which can configure the network type, SSIDs, encryption schemes, etc. The test fixture software may include provisions, such as user accessible screens and user interfaces, that allows networking information to be entered. This networking information can be applied to the device 110 using remote emulation commands. This can be used to verify the ability to configure the device for a particular network using commands from a remote, such as an infrared remote control.

Referring once again to FIG. 2, an act of displaying results is illustrated (act 212). In one embodiment this may be accomplished by displaying results at a display connected to, or part of, the test fixture 102. The test results may indicate success or failure of the testing. Additionally, the test results may provide an indication of portions of testing that succeeded and portions of testing that failed if such information is appropriate.

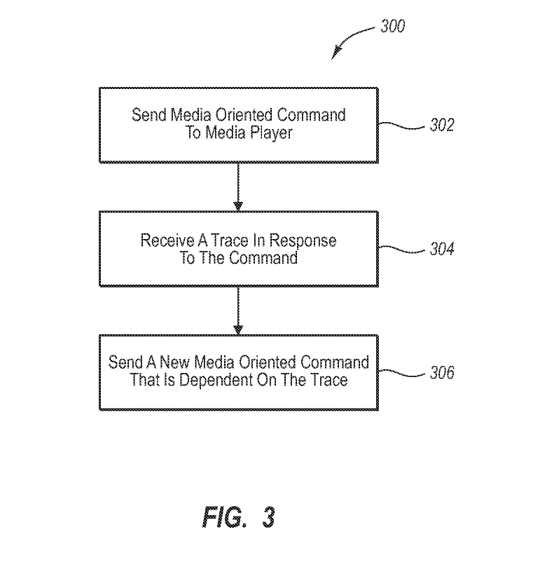

Referring now to FIG. 3, a method 300 is illustrated. The method 300 includes various acts for testing a media player. The method 300 may be practiced, for example, in an automated testing environment for testing media players. The method includes sending a media oriented command to the media player (act 302). The command directs the media player to perform a media function. For example, the command may specify a trick command such as play, pause, fast-forward, rewind, etc. Alternatively, the command may be a navigation command such as a menu navigation command such as one specifying a page up or page down selection, a file highlight command, or a select command to confirm selection of a file. The media oriented command may be sent, in one embodiment, by using a remote emulation command over a network.

FIG. 3 further illustrates an act of receiving a trace in response to the command (act 304). The trace includes media player information. The media player information occurs as a result of sending the command to the media player.

In response to receiving a trace, The method 300 further includes an act of sending a new media oriented command directing the media player to perform a media function (act 306). Sending a new media oriented command may be performed automatically and without human intervention. The new media oriented command is dependent on the trace.

Methods similar to method 300 in FIG. 3, but performed from the perspective of client media player devices may also be implemented. For example, in one embodiment, a media player may receive a media oriented command directing the media player to perform some media oriented function. Such a function may be, for example, a trick function such as play, pause, rewind, fast forward, etc. Alternatively, the media oriented command may be a navigation function such as those described previously.

In response to receiving the media command, the media player device may attempt to implement functionality identified by the media oriented command. The media player may further respond by sending a trace. The trace may be embedded in a file or in streaming media. The trace may include some of the same information that is in the file or in the streaming media. For example, the trace may include filename information, file position information, information related to activities for processing media, error information, etc.

The media player device may then receive a new media oriented command based on the information in the trace. For example, the new media oriented command may indicate that a new attempt should be made to play a file when an error is sent in the trace. The new media oriented command may specify a new file position, or a new file depending on the state of a previously played file.

Notably, some embodiments may implement testing safeguards or test programs specific to a given device. For example, a manufacturer may produce a number of devices, each with differing functionality. The test fixture may include functionality to ensure that appropriate testing is done for appropriate devices and that inappropriate testing is not performed. For example at act 202 where the test fixture connects to the device, or at act 208 where the test fixture licenses the device, or at any other appropriate step, the device may provide device information. In one embodiment, the device can provide a stock keeping unit (SKU) number. The SKU can be used to determine what functionality the device is intended to have. As such only testing appropriate to the intended functionality may be tested. Additionally, the SKU or other identifier may be dependent on individual components installed in the device. For example some device may include components supporting high definition video decoding while others only include standard definition components. Knowledge of the intended functionality and hardware capabilities can be used to prevent inappropriate firmware updates occurring at act 204.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In an automated testing environment for testing media players, a method of testing a media player, the method comprising:
sending a media oriented command to the media player, the command directing the media player to perform a media function;
receiving a trace in response to the command, the trace including media player information, the information occurring as a result of sending the command to the media player; and
in response to receiving a trace, automatically and without human intervention sending a new media oriented command directing the media player to perform a media function, wherein the new media oriented command is dependent on the trace.

2. The method of claim 1, wherein the media oriented command directing the media player to perform a media function is at least one of a play command, a pause command, a stop command, a fast-forward command, a rewind command, or a skip command.

3. The method of claim 1, wherein the media oriented command directing the media player to perform a media function is at least one of a menu command or a file selection command.

4. The method of claim 1, wherein the trace includes file position information.

5. The method of claim 1, wherein the trace includes information defining the name of a file being accessed.

6. The method of claim 1, wherein the trace includes error information.

7. The method of claim 6, wherein when the trace includes error information, sending a new media oriented command directing the media player to perform a media function comprises resending the original media oriented command.

8. The method of claim 1, wherein the trace includes information ordinarily displayed at a user interface.

9. The method of claim 1, wherein sending a media oriented command to the media player comprises sending a command over a network.

10. The method of claim 1, wherein sending a media oriented command to the media player comprises sending commands to configure the media player to operate on a specific network.

11. The method of claim 10, wherein sending commands to configure the media player to operate on a specific network comprises sending commands assigning at least one of an SSID and an encryption key specific to the specific network.

12. The method of claim 1, wherein the trace includes command execution status information.

13. The method of claim 1, wherein the trace includes media player state information.

14. The method of claim 1, further comprising displaying test results based on the media player information in the trace.

15. In an automated testing environment for testing media players, a method of testing a media player, the method comprising:
receiving a media oriented command at the media player, the command directing the media player to perform a media function;
attempting to perform a function defined by the media oriented command;
sending a trace in response to the command, the trace including media player information, the media player information occurring as a result of attempting to perform the function defined by the media oriented command; and
in response to sending a trace, receiving a new media oriented command that is generated automatically and without human intervention directing the media player to perform a media function, wherein the new media oriented command is dependent on the trace.

16. The method of claim 15, wherein the trace is embedded in a file.

17. The method of claim 15, wherein the trace is embedded in a media stream.

18. The method of claim 15, wherein the trace includes error information.

19. In an automated testing environment for testing media players, a computer readable medium comprising computer executable instructions, the computer executable instructions being configured to perform the following acts:
sending a media oriented command to the media player, the command directing the media player to perform a media function;
receiving a trace in response to the command, the trace including media player information, the media player information occurring as a result of sending the command to the media player; and
in response to receiving a trace, automatically and without human intervention sending a new media oriented command directing the media player to perform a media function, wherein the new media oriented command is dependent on the trace

20. The computer readable medium of claim 19, wherein the computer executable instructions are further configured to display test results based on the media player information in the trace.
